(19) United States
(12) Patent Application Publication
(10) Pub. No.: US 2005/0108081 A1
(43) Pub. Date: May 19, 2005

(54) Identification and evaluation of enterprise information for digitization

(75) Inventors: Robert A. Loe, Stillwater, MN (US); John M. Trusten, Shoreview, MN (US); Jerome L. Caldwell, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/717,398

(22) Filed: Nov. 19, 2003

(51) Int. Cl. G06F 17/60

(52) U.S. Cl. 705/10

(57) ABSTRACT

Techniques are described for the identification, evaluation, and prioritization of information for digitization. More specifically, the techniques described herein model the flow and aggregation of information within an enterprise. For example, a method is described in which an information flow model is developed to model the flow of information through a process of an enterprise. The information flow model defines at least one information component. The information flow model is analyzed to determine a potential return on investment if the information component were digitized. The information component is selectively digitized based the determined potential return on investment.

### TECHNICAL FIELD

The invention generally relates to digitization and, more particularly, to a process and techniques for identification, evaluation and prioritization of information for digitization.

### BACKGROUND

In recent years enterprises have widely implemented projects to “digitize” their printed information. By digitizing the information, the enterprises may hope to achieve any of a number of benefits. Example benefits that may be achieved with digitization include faster product designs, improved products, additional revenue streams, improved customer service, improved employee effectiveness, increased brand value, creation of intellectual property, more effective asset utilization, and the like. Examples of information that enterprises may want to digitize includes product brochures, user manuals, specifications, design documents, marketing brochures, user manuals, product information, customer information, competitive information, industry information and the like.

In general, enterprises have approached digitization with a “goal-driven” approach when deciding what information to digitize. In other words, the enterprises have focused on the goal that they were trying to achieve, and have digitized information within the enterprise in view of that goal. For example, if an enterprise determines that a web-presence is necessary and desirable to communicate product information to customers, the enterprise typically sets out by digitizing all finalized product information produced by the enterprise.

Within an enterprise, the amount of information that may be digitized, however, is often voluminous. Moreover, the digitization process may require significant investments in labor and material costs, e.g., cost associated with human resources to carry out the digitization as well as costs associated with digitization equipment, storage systems, and network access infrastructure systems. As a result, it is often difficult for the enterprises to achieve a reasonable return for the substantial investment that digitizing information often requires.

### SUMMARY

In general, the present application discloses techniques for the identification, evaluation, and prioritization of information for digitization. More specifically, the techniques described herein model the flow and aggregation of information within an enterprise. In particular, the techniques provide for the identification of “information components” that are used or developed within an enterprise, and allow the enterprise to model the use of the information components to form larger components or documents.

As used herein, the term “information component” refers to any portion of a printed or electronic document that may be separately digitized. For example, an information component may be a parts list produced by engineering, a target price list produced by marketing, legal requirements, translations, technical specifications, operating procedures, packaging graphics, trademark graphics, textual information generally, photography, video media, audio media, line art and the like.

Moreover, the term “digitized” herein generally refers to a process of transforming an information component into a digitally encoded form. For example, a printed brochure may be scanned to produce a digitized version of the brochure.

The techniques model the flow of these information components within an enterprise as the information components are created or used to form other information components. For example, a user interface specification may be one information component that is part of a requirements document used within a product development lab. That same user interface specification may also be used as an information component of a user's manual developed by technical service. The techniques allow an enterprise to precisely model how these information components may be used and reused across enterprise functions. As additional examples, information components may be aggregated to form technical user's manuals, marketing plans, design documents, product catalogs, design documents, requirement specifications, manufacturing specifications, training manuals, product manuals, web pages, brochures and the like.

According to the techniques described herein, an enterprise may develop “information flow models” to model internal business processes that lead to the creation or production of information components or final documents. As one example, an information flow model may be developed for a business process that leads or otherwise requires the creation of a marketing plan for a new product launch. Each information flow model defines the functions within the enterprise that play a role in the development process. In addition, each information flow model defines the tasks performed by the functions, as well as the information components that are created or used by each of the functions throughout the process. Example enterprise functions include marketing, legal, product management, technical service, manufacturing, and the like.

In addition to developing the models, the techniques also assign costs and resources to each task within a given information flow model, and identify the information components that are used by multiple processes or functions. This allows the enterprise to evaluate a potential benefit, e.g., a return on investment, that may be achieved by digitization of the information components. In other words, by digitizing the information components that are needed, created by, or used within processes of the enterprise, the techniques achieve and possibly maximize the cross-functional benefit to the digitization.

In one embodiment, a method comprises developing an information flow model to model the flow of information through a process of an enterprise. The information flow model defines at least one information component. The method further comprises analyzing the information flow model to determine a potential benefit if the information component were digitized, and selectively digitizing the information component based on the determined potential benefit.

In another embodiment, a method comprises identifying a set of processes within an enterprise, developing at least one cross-functional matrix that lists a set of information components associated with the processes and specifies an estimated use of the information components across functions within the enterprise, and selecting one of the processes based on the cross-functional matrix. The method further comprises developing a first information flow model to model the selected process and the use of the information components associated with the selected process, developing a second information flow model to model the selected process if one or more of the set of information components were digitized, and selectively digitizing the information components associated with the selected process based on the first information flow model and the second information flow model.

In another embodiment, a system comprises a value modeler software module executing on a computing device, wherein the value modeler software module processes an information flow model that models the flow of information through a process of an enterprise, and calculates a metric of improvement for the process if an information component associated with the process were digitized.

In another embodiment, a computer-readable medium comprises instructions that cause a processor to calculate a metric associated with a first information flow model that models the current flow of information through a process of an enterprise. The information flow model defines at least one information component. The instructions further cause the processor to calculate a metric associated with a second information flow model that models the flow of information through the process if the information components were digitized. The instructions further cause the processor to compare the metric of the first information flow model and the metric of the second information flow model to compute a potential benefit if the information component were digitized, and output a report that presents the potential benefit.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a flow diagram that illustrates the techniques in which information components created or used within business processes of an enterprise are identified, evaluated, and selectively digitized.

FIG. 2 is a flowchart that illustrates the techniques in further detail.

FIG. 3 is a block diagram illustrating an example system in which information components are selectively digitized according to the techniques described herein and then dynamically reassembled.

FIG. 4 illustrates exemplary business processes performed by enterprise functions.

FIG. 5 illustrates an example cross-functional matrix developed to identify candidate information components for digitization.

FIG. 6 illustrates an exemplary information flow model of a selected business process.

FIG. 7 illustrates another more specific exemplary information flow model.

FIG. 8 illustrates an example user interface by which a user assigns properties to a given task of an information flow model.

FIG. 9 illustrates an example user interface presented by a value modeler used in evaluating a potential return on investment associated with digitization of information components.

FIG. 10 illustrates an example user interface presented by the value modeler when the user elects to view tasks defined for a modeled business processes.

FIG. 11 illustrates an example report generated by the value modeler when the user elects to view a financial report for an information flow model.

FIG. 12 illustrates another example report generated by the value modeler when the user elects to compare multiple information flow models.

### DETAILED DESCRIPTION

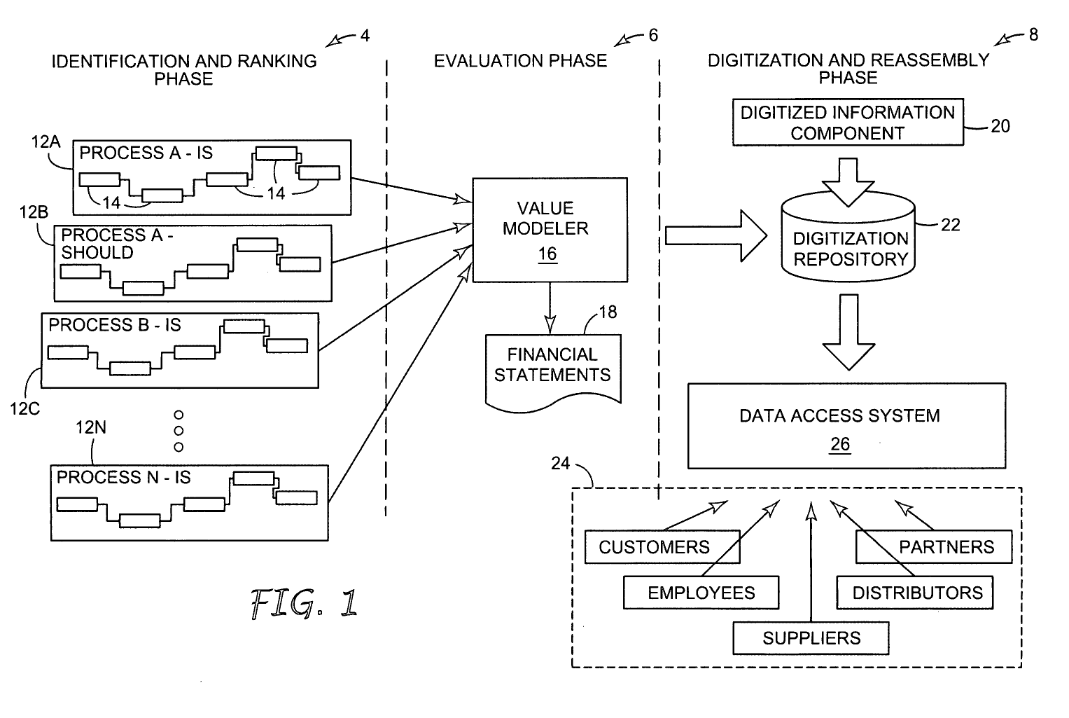

FIG. 1 is a flow diagram that illustrates the techniques for identifying and evaluating information components within an enterprise that are candidates for digitization. As illustrated in FIG. 1, the techniques generally involve three phases: an identification and ranking phase 4, an evaluation phase 6, and a digitization and reassembly phase 8.

In the identification and ranking phase 4, information flow models 12A-12N (collectively “information flow models 12”) are developed for internal business processes that relate to the creation or use of “information components.” As one example, an information flow model may be developed for a business process that requires the creation or use of a marketing brochure for a new product launch.

Each of information flow models 12 defines the functions within the enterprise that play a role in the process. In particular, each of information flow models 12 define a set of tasks 14 performed by the functions, as well as the information components that are created or used by each of the functions throughout the process. Example enterprise functions include marketing, legal, product management, technical service, manufacturing, and the like.

In this example, information flow model 12A is referred to as an “IS” model for process A, which generally represents an associated business process that leads to one or more information components. The process is referred to as an “IS” process in that the process is currently used or operational in the enterprise. In contrast, information flow model 12B is referred to as a “SHOULD” model for process A, and represents a proposed improved or alternative workflow for the enterprise process. Information flow models 12B, 12N are “IS” models for the corresponding business processes of the enterprise. Similarly, one or more “SHOULD” models may be developed for each of these business processes.

During the identification and ranking phase 4, candidate information components used or created within the process are identified and ranked based on their common usage across functions of the enterprise. Examples of enterprise functions include marketing, research and development, technical service, sales, and the like. Information flow models 12 model the flow of information through processes within the enterprise functions, and allow an understanding to be developed for the assembly of the information components within the enterprise. In other words, the techniques provide for the modeling of the hierarchical information flow and aggregation performed across functions of the enterprise. In one embodiment, software is used to graphically layout the information flow models 12, and to assign labor and material costs to each of tasks 14.

As used herein, the term information component refers to any portion of an electronic document that may be separately digitized. For example, an information component may be a parts list produced by engineering, a target price list produced by marketing, legal requirements, translations, technical specifications, operating procedures, packaging graphics, trademark graphics, textual information generally, photography, video media, audio media, line art, product catalogs, design documents, requirement specifications, manufacturing specifications, training manuals, product manuals, web pages, brochures, and the like. Moreover, the term “digitized” herein generally refers to a process of transforming an information component into a digitally encoded form. For example, a printed brochure may be scanned to produce a digitized version of the brochure.

In evaluation phase 6, the techniques provide for the evaluation of a potential financial return associated with the digitization and reuse of the information components used in the business processes modeled by information flow models 12. In particular, value modeler 16 provides an analysis environment in which information flow models 12 can be compared and contrasted. Based on the costs defined for tasks 14 of the different information flow models 12, value modeler 16 can be used to measure an actual impact on the enterprises financial statements 18 for each identified information component. In other words, value modeler 16 can calculate the potential benefit, e.g., return on investment (ROI), and direct benefit of digitizing a given information component.

In digitization and reassembly phase 8, select information components of the enterprise are digitized based on the respective value proposition computed during evaluation phase 6. This process of collecting and digitizing the information components typically has an associated cost, and the potential financial return computed during evaluation phase 6 aids the enterprise in determining whether the preparation costs are justified.

In the digitization and reassembly phase 8, the digitized information components 20 are indexed and placed in a digitization repository 22 for access by parties 24. For example, digitized information components 20 of repository 22 may be dynamically reassembled, e.g., via a data access system 26, (e.g., a web-based system that may make use of the Internet or an intranet) to provide enterprise-wide information to customers, business partners, suppliers, distributors, employees, and the like. As one example, a web-presence for the enterprise may utilize digitized information components 20 by dynamically selecting and recombining the digitized components to form web pages that convey the assembled information. In response to an access request from one of parties 24, data access system 26 can readily provide electronic documents, e.g., product information, technical information, marketing information, sales information, distribution information, regulatory approval information, or combinations thereof, by selectively retrieving and reassembling digitized information components 20 from repository 22.

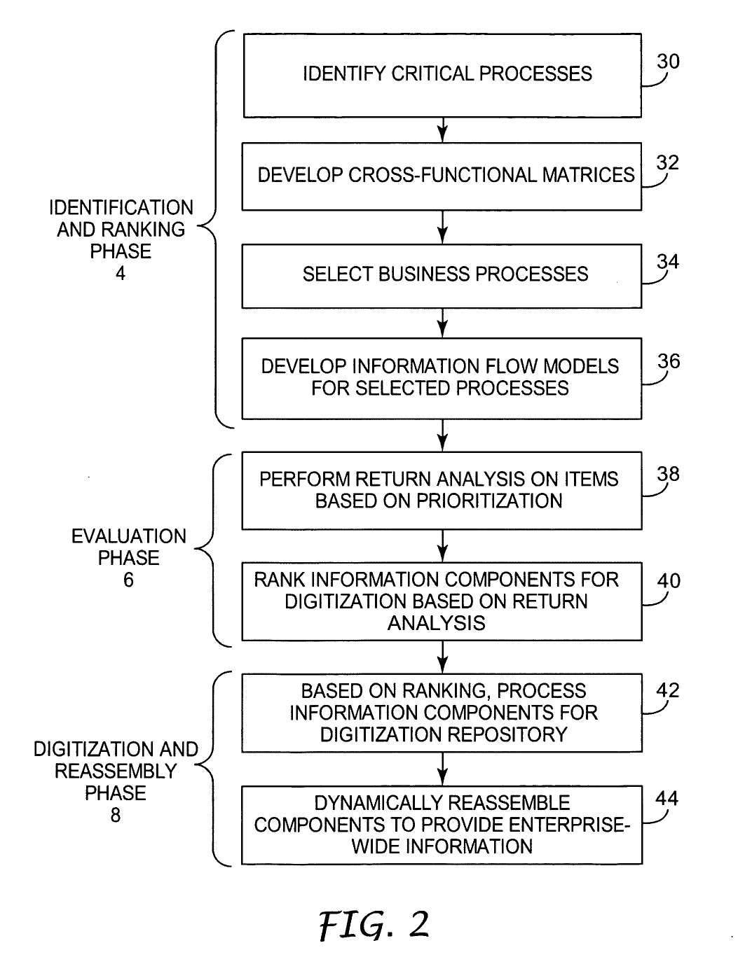

FIG. 2 is a flowchart that illustrates identification and ranking phase 4, evaluation phase 6, and digitization and reassembly phase 8 of FIG. 1 in further detail.

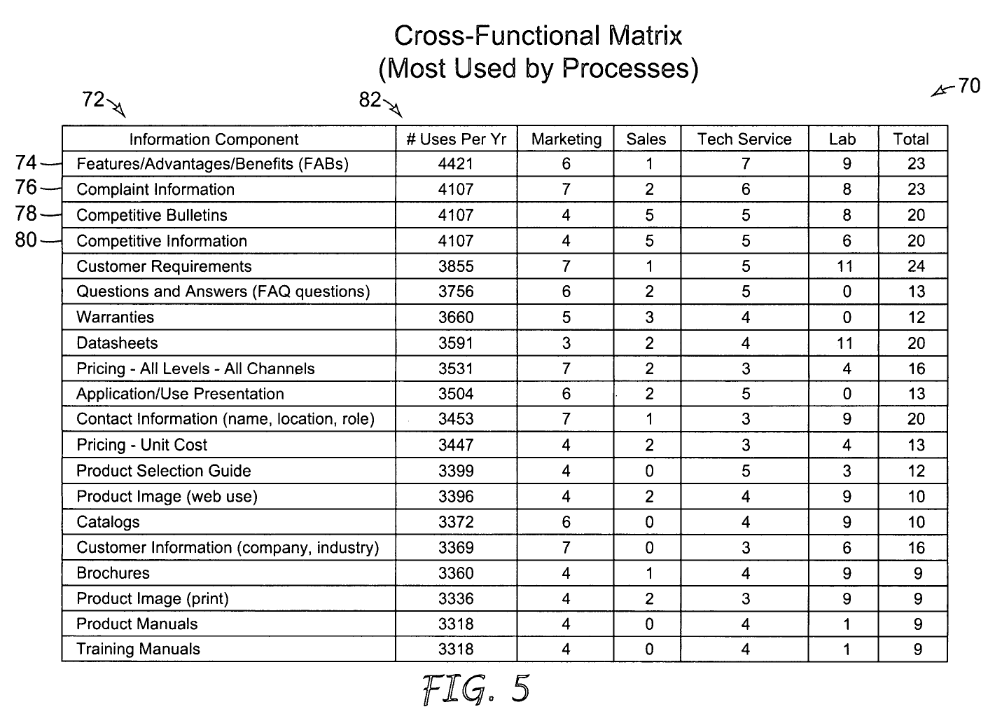

Initially, critical business processes within the enterprise are identified (30), and one or more cross-functional matrices are developed (32). The cross-functional matrices identify the information components used within the critical business processes, and provide an indication of the cross-functional use of each information component (see FIG. 5) within the enterprises. In addition, the cross-functional matrices may rank the information components based on an estimated number of uses of information components within a defined period, e.g., the number of uses in one year.

Based on the cross-functional matrices, a set of one or more of the business processes is selected for further analysis (34). For example, the commonality of use of the information components across business processes, as well as the total estimated usage for the information components, may be used to prioritize the business process for further analysis. In this manner, the enterprise matrices aid in the identification and selection of business processes that relate to information components for which a return on investment or other metric of improvement may be achieved if the information components were digitized.

Next, information flow models 12 are developed for the selected critical business processes (36). As described, a typical information flow model, e.g., information flow model 12A, models a business process that relates to the use of or creation of information components. A financial impact and return analysis is then performed to calculate a potential return associated with each of the digitization of identified information components (38).

Initially, each of information flow models 12 is imported into value modeler 16. As described in detail herein, value modeler 16 is a software module that provides an analytical environment for evaluating and comparing information flow models 12, e.g., based on associated costs, resources, and the like. For example, in one embodiment information flow models 12 are created using graphical design software, such as Visio™ from Microsoft Corporation of Redmond, Wash. A “plug-in” is used to export data that describes all attributes of the information flow model being exported, including the process tasks and their interrelationship, the enterprise functions that perform the tasks, and the costs and resources associated with each of the tasks. Value modeler 16 may then be used to assess the financial impact to the enterprise if the information components used or created within the process were digitized.

For example, as illustrated in FIG. 1, a model may be developed for the current business process, e.g., PROCESS A—IS, as well as the hypothetical process arising from the digitization of one or more information components associated with the process, e.g., PROCESS A—SHOULD. Value modeler 16 allows the various models to be compared, and potential returns to the enterprise to be assessed. The returns may take the form of any of a number of improvement metrics, such as increased quality, reduced cycle time, productivity, cost reduction, increased revenue, reduced translation costs, and the like. In this manner, the techniques can be used to prioritize the digitization of information components, and to help justify the cost associated with their digitization.

In other words, PROCESS A—SHOULD provides a model of the process in which some or all of the associated information components are digitized. Value modeler 16 can attribute cost savings to PROCESS A—SHOULD based on a comparison with PROCESS A —IS. Thus, value modeler 16 provides a more accurate assessment of the value of digitizing PROCESS A by accounting for economies that can be achieved by reuse of the digitized information of PROCESS A in that process and within other processes of the enterprise.

Based on the results of the return analysis provided by value modeler 16, the information components are prioritized, e.g., ranked (40), and selectively digitized for aggregation within the digitization repository 22 (42). The information components can then be dynamically reassembled to provide enterprise-wide information to parties 24, e.g., customers, business partners, suppliers, distributors, employees, and the like.

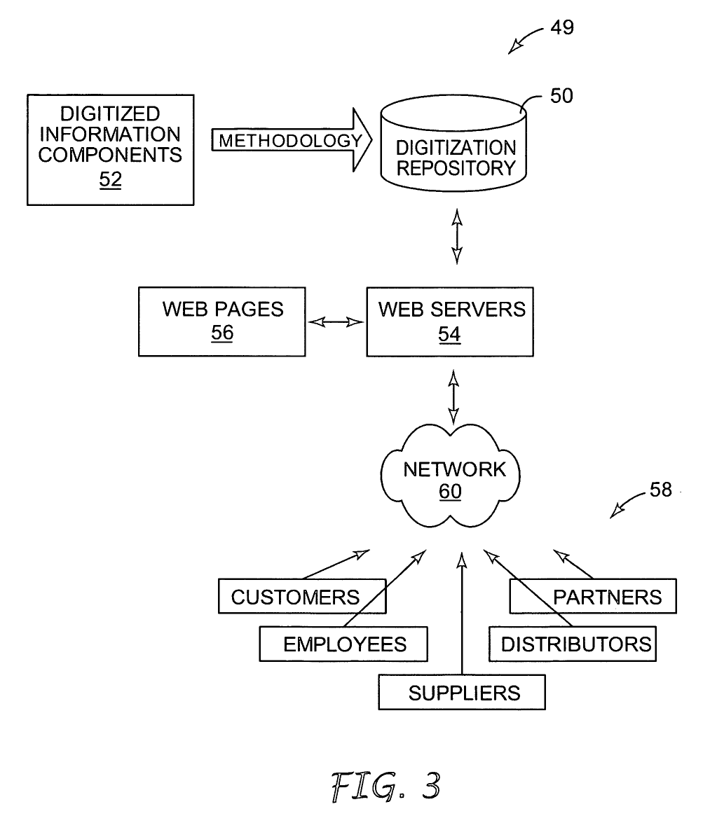

FIG. 3 illustrates an example system 49 in which information components created by or used within business processes of an enterprise are identified, evaluated, and selectively digitized according to the techniques described herein. In the illustrated embodiment, digitized information components 52 are stored within digitization repository 50. Digitization repository 50 may be implemented in a variety of different forms, and may comprise a number of file servers, database servers, or both. The digitized components may be stored, for example, via the file servers, and retrievable via a database management system (DBMS) executing on the database servers. The database management system may be relational (RDBMS), hierarchical (HDBMS), multidimensional (MDBMS), object oriented (ODBMS or OODBMS), object relational (ORDBMS), or the like.

In the exemplary system 49, web servers 54 dynamically generate web pages 56 for a customer-oriented website of the enterprise. In particular, web servers 54 retrieve the digitized information components 52 from digitization repository 50, and dynamically generate web pages 56 for presentment to parties 58 via network 60. For example, the web server dynamically generates web pages by retrieving digitized information components 52, and reassembling the digitized information components to provide enterprise information, e.g., product information, pricing information, marketing brochures, user manuals, and the like. In this manner, web servers 54 need not necessarily rely on statically defined web-pages. As a result, web servers 54 may more efficiently generate up-to-date and comprehensive enterprise information.

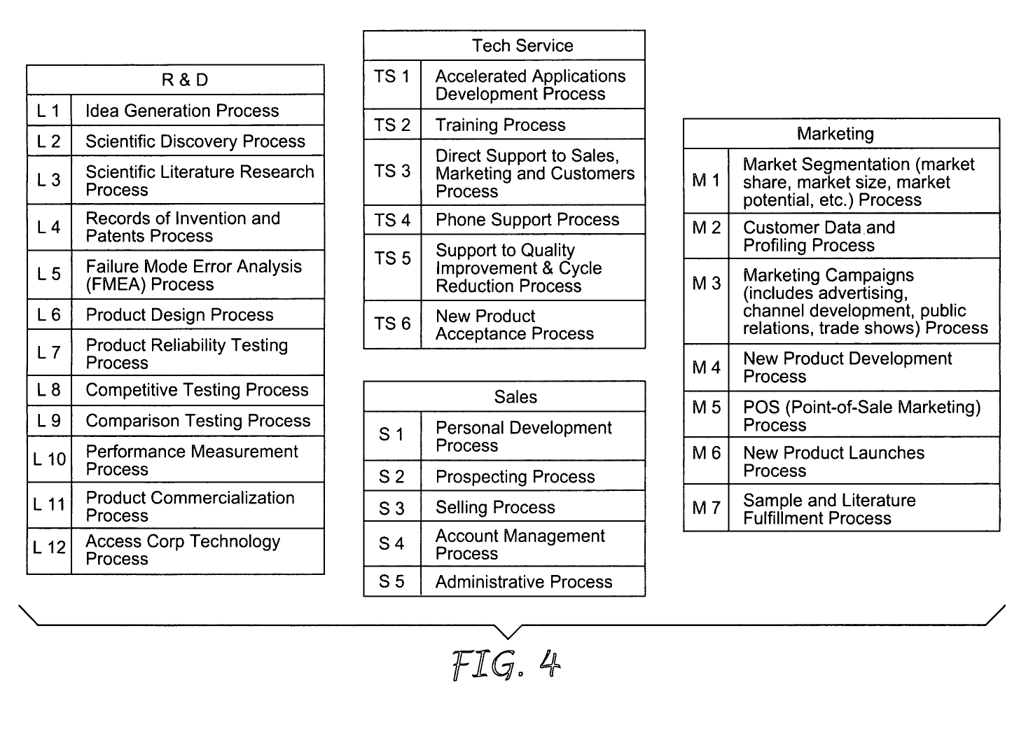

FIG. 4 illustrates exemplary critical business processes performed by enterprise functions, and that may be candidates for further analysis. In this example, critical business processes performed by technical service function include: accelerated applications development, training, direct support to sales marketing and customers, phone support, quality improvement and cycle reduction, and new product acceptance. Similarly, critical business processes are listed for marketing, sales, and research and development (R&D).

FIG. 5 illustrates an example cross-functional matrix 70 developed to identify candidate information components for evaluation and digitization. In the illustrated example, cross-functional matrix 70 includes a first column 72 that lists the information components created or used during the critical business processes previously identified, as illustrated in FIG. 4. Some of the exemplary information components include: features/advantages/benefits (FABs) lists 74, compliant information 76, competitive bulletins 78, and competitive information 80.

Column 82 lists the number of uses for each of the information components during a given time period, e.g., a year, for all of the processes and across all functions. The remaining columns list the number of processes for each enterprise function that use the corresponding information component listed in column 72. For example, cross-functional matrix indicates that the FAB list 74 is used an estimated 4221 times per year within six marketing processes, one sales process, seven technical service processes, and nine lab processes.

As described in reference to the flowchart of FIG. 2, cross-functional matrix provides insight as to which one or more of the identified business processes are candidates for further modeling and analysis using value modeler 16. Moreover, the cross-functional matrix allows for assessment of cross-economies that can be achieved by digitization of various information components.

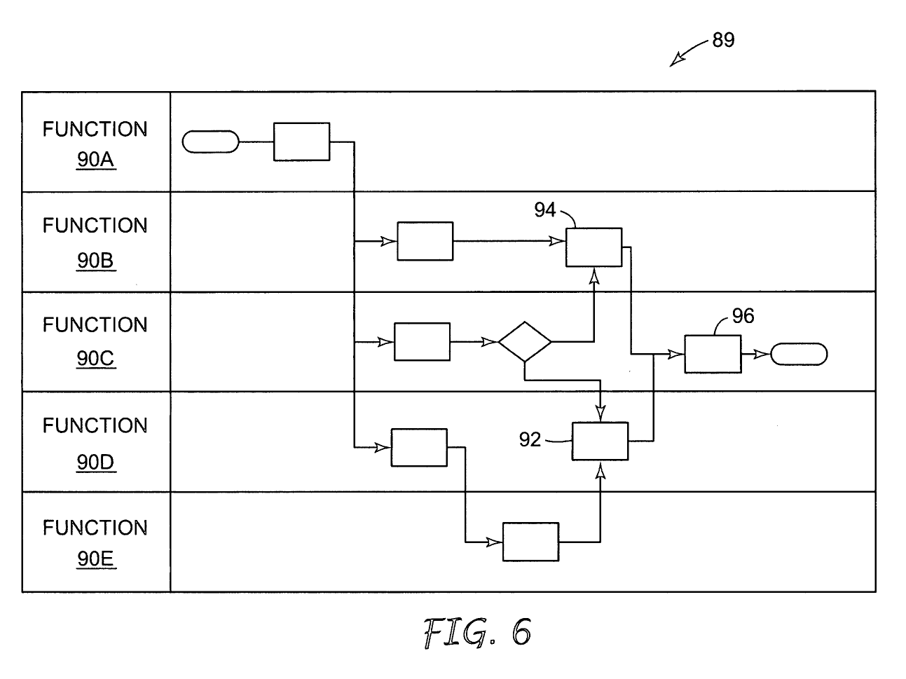

FIG. 6 illustrates an exemplary information flow model 89 in a generalized form. In the illustrated example, information flow model 89 includes five rows, and each row corresponds to a different enterprise function 90A-90E. Example enterprise functions include marketing, legal, product management, technical service, manufacturing, and the like. Each of the rows of information flow model 89 graphically illustrates the tasks performed by the corresponding enterprise functions 89. Moreover, information flow model 89 defines the interrelations and dependencies between the tasks, thereby modeling the business process.

The tasks of information flow model 89 lead to the use or development of one or more information components. For example, the business process being modeled may lead to the use or development of FABs 74 (FIG. 5), compliant information 76, competitive bulletins 78, or other information components. Moreover, the dependencies depicted in information flow model 89 illustrate the flow of information components through the business process, and how certain information components are aggregated to form other information components. For example, tasks 92, 94 may lead to the creation of a user interface requirement specification and a parts list, respectively. Task 96 may utilize these information components to form a manufacturing specification document.

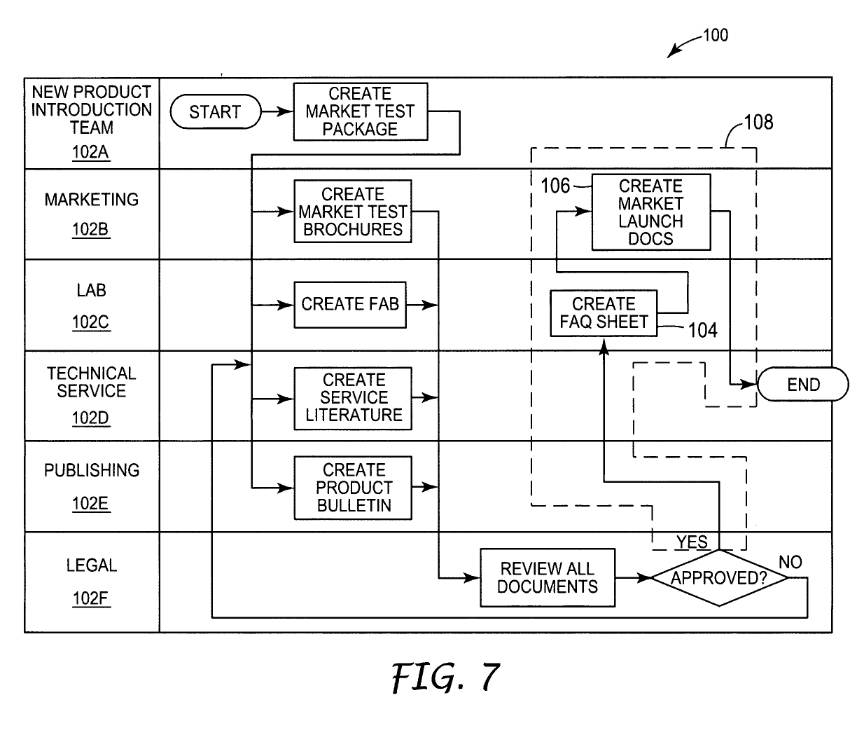

FIG. 7 illustrates an exemplary information flow model 100. In this example, information flow model 100 models a business process that involves interaction between six enterprise functions: (1) new product introduction team 102A, marketing 102B, lab 102C, technical service 102D, publishing 102E, and legal 102F. As illustrated, the modeled business process leads to the use or creation of a number of information components, i.e., a marketing test package, market brochures, a FAB list, service literature, a product bulletin, a FAQ sheet, and market launch documents. In one embodiment, software is used to graphically layout the information flow model 100, and to assign a variety of “properties” to each task, including resources as well as labor and material costs.

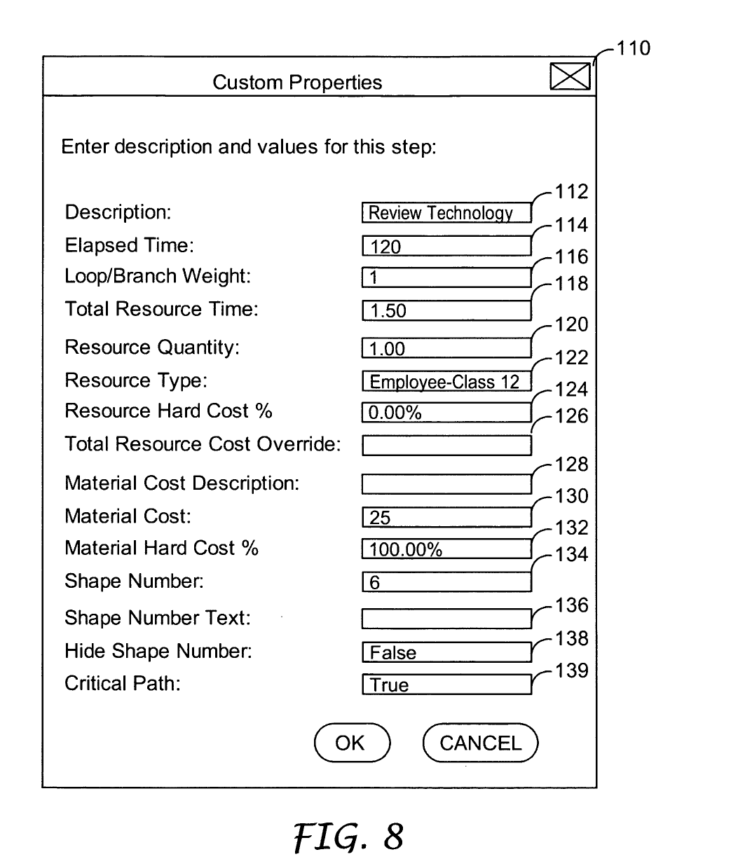

FIG. 8 illustrates an example user interface 110 by which a user assigns properties to a given task of an information flow model when creating the information flow model. User interface 110 may be presented by, for example, graphical design software that is used to graphically define the information flow model and illustrate the flow of the information through the process.

For example, user interface 110 includes a text input region by which the user supplies a description of the task 112, e.g., “Review Technology.” In addition, the user interface includes input regions by which the user may provide an elapsed time 114 that specifies the total amount of time that elapses from start to completion of the task, a loop/branch weight 116 that indicates the percentage of time the task is actually performed, a total resource time 118 that indicates the total time (in days) expended by a resource, a resource quantity 120 that indicates the total resources allocated to the task, a type of resource allocated 122, a hard cost associated with the resource 124, an optional override value 126 for the resource cost that allows the user to override the total cost otherwise calculated by value modeler 16, a material description 128, a material cost (in dollars) 130, a percentage of material hard cost 132, a shape number 134 assigned to the shape that graphically illustrates the task, shape number text 136 that may be displayed within the model to assist the user in identifying the corresponding task, and an optional flag 138 to hide or display the shape number.

In one embodiment, user interface 110 allows the user to input a designator 139 that indicates whether the given task should be treated as within a “critical path” of the information flow model. In particular, this feature allows the user to temporarily override the loop/branch weight 116 that otherwise indicates the percentage of time the task is performed. For example, the user may temporarily indicate that a particular branch of one or more tasks is performed 100% of the time, i.e., that the branch is to be treated as a “critical path.” The user may then assess the financial impact and return for the information flow model in view of this temporary assumption. This allows the user to model and assess the financial impact that the different branches have on the internal business process being modeled.

As one example, the user may temporarily indicate that tasks 104 and 106 of FIG. 7 are on a critical path 108 and, therefore, occur 100% of the time. In response, the graphical design software may present a visual indication that path 108 is currently being designated as a critical path. For example, the software may modify the visual representation of path 108, including tasks 104 and 106, e.g., by displaying the path in red. The user may then invoke value modeler 16 (FIG. 1) to perform financial analysis on information flow model 100 based on the assumption that path 108 is a critical path.

In addition to or instead of a “critical path”, other paths within the information flow model can be selected by the user for analysis in the same way. In those cases, certain tasks will be designated and treated as within the “selected path” of the information flow model.

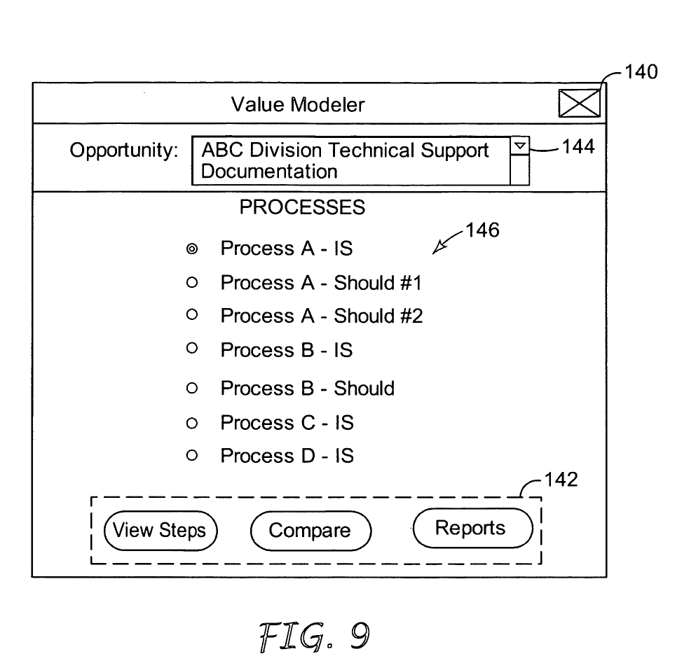

FIG. 9 illustrates an example user interface 140 presented by value modeler 16 after one or more models have been imported from the graphical design software. As illustrated in FIG. 9, user interface 140 allows the user to select an “opportunity” 144 for which one or more modeled processes have been imported for analysis. In the illustrated example, the “ABC Division Technical Support Documentation” opportunity is selected, for which seven information flow models 146 are defined.

By interacting with user interface 140, the user is able to select one or more information flow models 146 associated with the selected opportunity 144. The user may then interact with buttons 142 to view the detailed tasks within the selected information flow model, direct value modeler 16 to perform financial analysis to compare multiple flow models, or generate evaluation reports for the selected information flow models.

In one embodiment, value modeler 16 is implemented within a relational database environment, e.g., Access™ by Microsoft Corporation of Redmond, Wash.

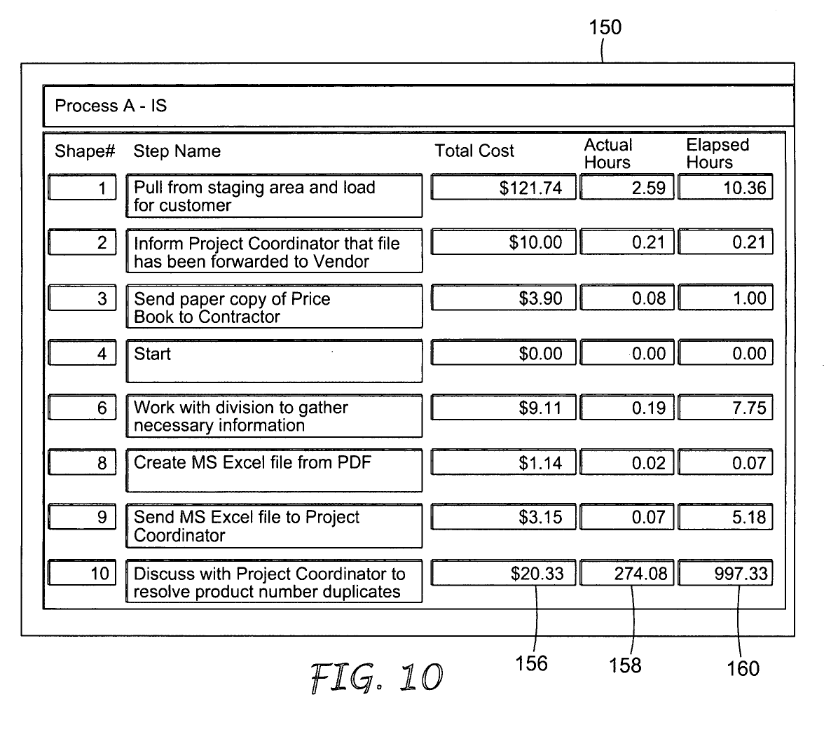

FIG. 10 illustrates an example user interface 150 presented by value modeler 16 when the user elects to view the tasks defined for one of information flow models 146. In particular, value modeler 16 displays the corresponding shape numbers for each of the tasks, a description of the task, total costs for the tasks as calculated from the assigned properties, calculated actual hours, calculated elapsed hours, and the like. Moreover, user interface 150 presents a total cost 156, total actual hours 158, and total elapsed hours 160, or other indicators that may be calculated for the process by value modeler 16. In this manner, value modeler 16 may be used to provide insight into the impact of the process on quality, cycle time, productivity, cost, revenue, translation costs, and the like.

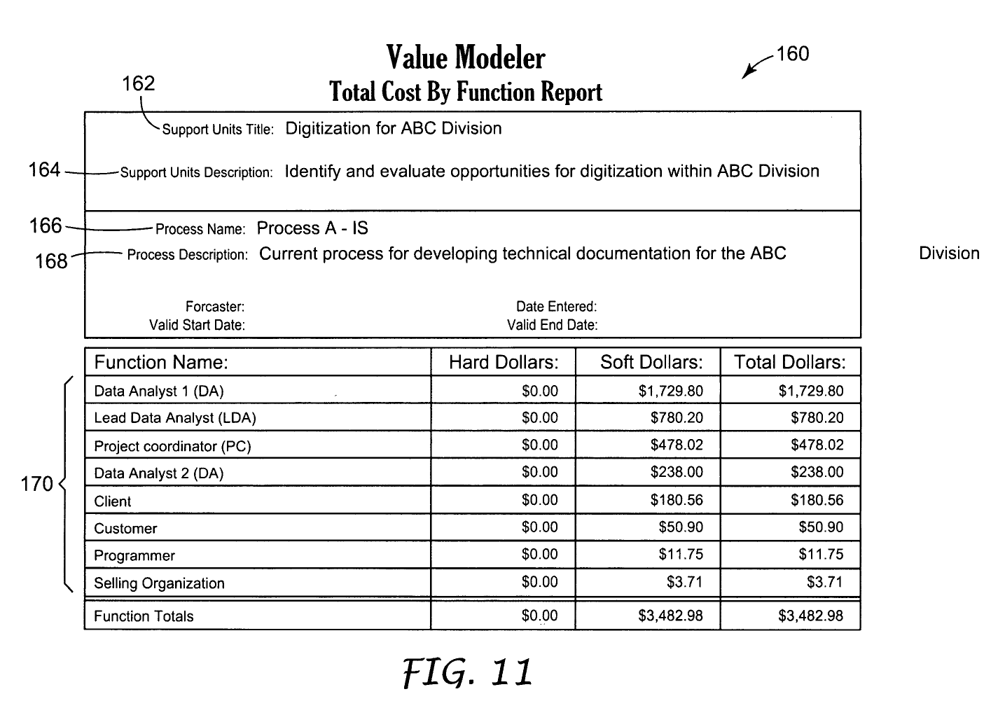

FIG. 11 illustrates an example report 160 generated by value modeler 16 when the user elects to view a financial report for an information flow model 146. As illustrated, value modeler 16 generates report 160 to include an opportunity title 162, an opportunity description 164, a name 166 of the process being modeled, and a description 168 of the process.

Report 160 lists the functions 170 defined by the information flow model, and the computed hard dollars, soft dollars, and total dollars for each function expended during the process. In addition, report 160 lists total hard dollars, total soft dollars, and total dollars expended during the modeled business process as computed by value modeler 16.

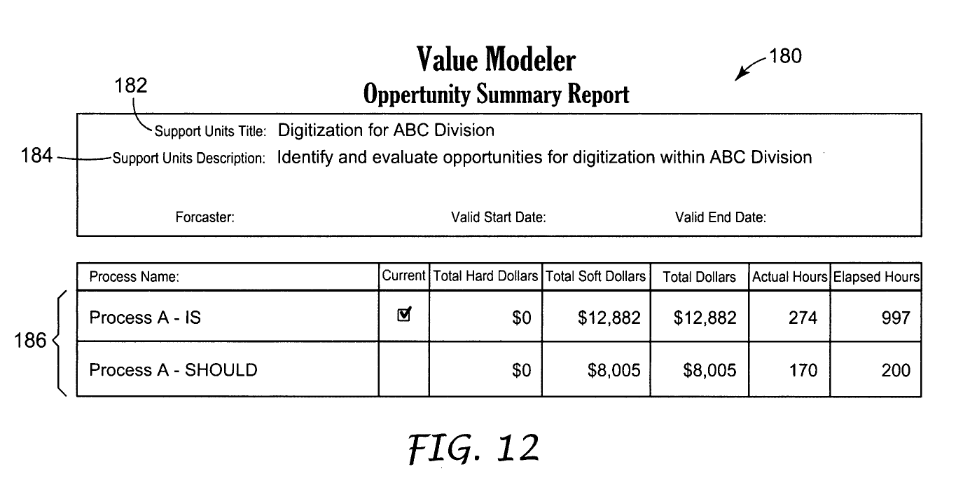

FIG. 12 illustrates another example report 180 generated by value modeler 16 when the user elects to compare multiple information flow models 146 (FIG. 9). As illustrated, value modeler 16 generates report 180 to include an opportunity title 182, an opportunity description 184, and a list 186 of the information flow models 146 being compared.

For each information flow model, report 180 lists the hard dollars, soft dollars, total dollars, actual hours, and elapsed hours for each process as computed by value modeler 16. In the example, value modeler 16 computes the total dollars for Process A—IS as $12,882, and the total dollars for Process A—SHOULD as $8,005. In other words, if the enterprise makes use of the digitized information components defined in Process A—SHOULD, the enterprise would expect to achieve a 37.9% reduction in total dollars. In this manner, value modeler 16 allows an enterprise to compare different hypothetical processes that make use of digitized information components. Based on the analysis, the enterprise is able to assess the impact of the digitization on a number of corporate metrics, such as increased quality, reduced cycle time, productivity, cost reduction, increased revenue, reduced translation costs. Accordingly, the enterprise can utilize the financial reports generated by value modeler 16 to prioritize and selectively digitize information components for aggregation within the central repository 22.

Various implementations and embodiments of the invention have been described. Nevertheless, it is understood that various modifications can be made without departing from the invention. Accordingly, these and other embodiments are within the scope of the following claims.

1. A method, comprising:
developing an information flow model that models the flow of information through a process of an enterprise, wherein the information flow model defines at least one information component associated with the process;
analyzing the information flow model to determine a potential benefit if the information component were digitized; and
selectively digitizing the information component based on the determined benefit.

2. The method of claim 1, wherein analyzing the information flow model comprises:
calculating a metric associated with the information flow model; and
determining the potential benefit based on the calculated metric.

3. The method of claim 2, wherein the metric comprises one of quality, cycle time, productivity, cost, and revenue.

4. The method of claim 2, wherein analyzing the information flow model further comprises:
importing the information flow model into a value modeler; and
automatically computing a metric associated with the process with the value modeler.

5. The method of claim 1, further comprising:
identifying a set of processes within the enterprise;
developing at least one cross-functional matrix that specifies a plurality of information components associated with the processes and a usage of the specified information components across a plurality of functions within the enterprise;
selecting one of the processes based on the cross-functional matrix; and
developing the information flow model for the selected process.

6. The method of claim 5, wherein developing at least one cross-functional matrix comprises specifying an estimated number of uses by each of the enterprise functions for each of the information components.

7. The method of claim 5, wherein developing the cross-functional matrix comprises developing the cross-functional matrix to list for each of the information components an estimated number of processes within each of the enterprise functions that makes use of that information component.

8. The method of claim 1, wherein developing an information flow model comprises graphically illustrating the flow of information through the process.

9. The method of claim 1, wherein developing an information flow model comprises:
defining a set of tasks associated with the process; and
assigning properties to each of the tasks to represent enterprise costs associated with the tasks.

10. The method of claim 9, wherein developing an information flow model comprises interrelating the tasks based on dependencies between the tasks.

11. The method of claim 9, wherein developing an information flow model comprises:
defining a set of enterprise functions involved in the process; and
mapping the tasks to the enterprise functions.

12. The method of claim 9, wherein assigning properties to each of the tasks comprises presenting a user interface that includes one or more of:
an input region to receive a description of the task;
an input region to receive an elapsed time that specifies the total amount of time that elapses from start to completion of the task;
an input region to receive a loop/branch weight that indicates the percentage of time the task is actually performed;
an input region to receive a total resource time that indicates the total time expended by a resource during the task;
an input region to receive a resource quantity that indicates the total resources allocated to the task;
an input region to receive a type of resource allocated to the task;
an input region to receive a hard cost associated with the resource;
an input region to receive a material cost associated with the task; and
an input region to receive a percentage of material hard cost associated with the task.

13. The method of claim 9, further comprising:
computing one or more total costs associated with the information flow model based on the assigned properties; and
generating a financial report that presents the computed total costs.

14. The method of claim 13, wherein computing one or more total costs comprises computing at least one of total hard dollars, total soft dollars, and total dollars for each of a set of enterprise functions associated with the process.

15. The method of claim 13, wherein computing one or more total costs comprises computing at least one of total hard dollars, total soft dollars, and total dollars expended during the modeled process.

16. The method of claim 1, wherein the information flow model comprises a first information flow model that models current operation of the process, the method further comprising:
developing a second information flow model to model the flow of information through the process if the information component were digitized;
calculating a metric associated with the first information flow model and a metric associated with the second information flow model; and
comparing the metric associated with the first information flow model to the metric associated with the second information flow model to determine the potential return on investment if the information component were digitized.

17. The method of claim 16, wherein the metrics comprises a total costs for the respective processes.

18. The method of claim 16, wherein the metrics provide measurements of one of quality, cycle time, productivity, cost, of revenue.

19. The method of claim 16, further comprising generating a financial report that lists at least one of total hard dollars, total soft dollars, and total dollars for each of the processes modeled by the first and second information flow models.

20. The method of claim 16, further comprising generating the financial report to list an expected percent reduction in total costs if the information component were digitized.

21. The method of claim 1, further comprising storing the digitized information component within a repository with other digitized information components.

22. The method of claim 21, further comprising:
retrieving a subset of the digitized components from the repository in response to a user request for an electronic document;
reassembling the retrieved digitized information components to form the electronic document; and
presenting the electronic document to the user.

23. The method of claim 1, wherein analyzing the information flow model comprises determining a return on investment if the information component were digitized.

24. The method of claim 22, wherein presenting the electronic document comprises communicating the electronic document via a network to a client computer associated with the user.

25. The method of claim 1, wherein the information component is created during the process.

26. The method of claim 1, wherein the information component is used but not created during the process.

27. A method, comprising:
identifying a set of processes within an enterprise;
developing at least one cross-functional matrix that lists a set of information components associated with the processes and specifies an estimated use of the information components across functions within the enterprise;
selecting at least one of the processes based on the cross-functional matrix;
developing a first information flow model to model the selected process and the use of the information components associated with the selected process;
developing a second information flow model to model the selected process if one or more of the set of information components associated with the selected process were digitized;
comparing the first information flow model and the second information flow model; and
selectively digitizing the information components associated with the selected process based on the comparison.

28. The method of claim 27,
wherein comparing comprises analyzing the first information flow model and the second information flow model to determine a potential return on investment if the information component were digitized, and
wherein selectively digitizing comprises selectively digitizing the information components based on the determined potential return on investment.

29. The method of claim 27, wherein comparing comprises:
calculating a metric associated with the first information flow model and a metric associated with the second information flow model; and
comparing the metric associated with the first information flow model to the metric associated with the second information flow model to determine the potential return on investment if the information component were digitized.

30. A system comprising a value modeler software module executing on a computing device, wherein the value modeler software module processes an information flow model that models the flow of information through a process of an enterprise, and calculates a metric of improvement for the process if at least one information component associated with the process were digitized.

31. The system of claim 30, wherein the metric comprises one of quality, cycle time, productivity, cost, and revenue.

32. The system of claim 30, wherein the value modeler comprises a database that stores data defining the information flow model as a set of tasks associated with the process, wherein the data defines relationships based on dependencies between the tasks.

33. The system of claim 32, wherein the value modeler presents a user interface for assigning costs to each of the tasks.

34. The system of claim 30, wherein the data defines a set of enterprise functions involved in the process, and maps the tasks to the enterprise functions.

35. The system of claim 30, further comprising graphical design software that illustrates the flow of the information through the process.

36. The system of claim 30, wherein the graphical design software presents a user interface that includes one or more of:
an input region to receive a description of the task;
an input region to receive an elapsed time that specifies the total amount of time that elapses from start to completion of the task;
an input region to receive a loop/branch weight that indicates the percentage of time the task is actually performed;
an input region to receive a total resource time that indicates the total time expended by a resource during the task;
an input region to receive a resource quantity that indicates the total resources allocated to the task;
an input region to receive a type of resource allocated to the task;
an input region to receive a hard cost associated with the resource;
an input region to receive a material cost associated with the task; and
an input region to receive a percentage of material hard cost associated with the task.

37. The system of claim 30, wherein the value modeler computes one or more total costs associated with the information flow model, and generates a financial report that presents the computed total costs.

38. The system of claim 30, wherein the value modeler computes at least one of total hard dollars, total soft dollars, and total dollars for each of a set of enterprise functions associated with the process.

39. The system of claim 30, wherein the value modeler computes at least one of total hard dollars, total soft dollars, and total dollars expended during the modeled process.

40. The system of claim 30, wherein the information flow model comprises a first information flow model that models current operation of the process, and the value modeler calculates the metric by processing a second information flow model that models the flow of information through the process if the information component were digitized.

41. The system of claim 30, wherein the value modeler calculates respective metrics associated with the first information flow model and the second information flow model, and compares the metrics to determine a potential benefit if the information component were digitized.

42. The system of claim 41, wherein the value modeler compares the metrics to determine a potential return on investment if the information component were digitized.

43. The system of claim 30, further comprising a digitization repository to store the digitized information component with other digitized information components.

44. The system of claim 43, further comprising a computer to retrieve the digitized information components from digitization repository, and dynamically generate display output from the digitized information components.

45. The system of claim 43, wherein the digitization repository comprises:
a file server to store the digitized information components; and
a database management system to provide an index for retrieving the digitized component.

46. The system of claim 45, wherein the database management system comprises one of a relational database management system, a hierarchical database management system, a multidimensional database management system, an object-oriented database management system, and an object-relational database management system.

47. A computer-readable medium comprising instructions that cause a programmable processor to:
calculate a metric associated with a first information flow model that models the current flow of information through a process of an enterprise, wherein the information flow model defines at least one information component;
calculate a metric associated with a second information flow model that models the flow of information through the process if the information component were digitized;
compare the metric of the first information flow model and the metric of the second information flow model to compute a potential benefit if the information component were digitized; and
output a report that presents the potential benefit.

48. The computer-readable medium of claim 47, wherein the metric comprises one of quality, cycle time, productivity, cost, and revenue.

49. The computer-readable medium of claim 47, wherein the instructions cause the processor to compute at least one of total hard dollars, total soft dollars, and total dollars expended during the modeled processes.

50. The computer-readable medium of claim 47, wherein the potential benefit comprises a potential return on investment.
